(19) United States
(12) Patent Application Publication
(10) Pub. No.: US 2003/0054323 A1
(43) Pub. Date: Mar. 20, 2003

(54) Flight instruction educational system and method

(76) Inventor: Jay D. Skaggs, Boynton Beach, FL (US)

Correspondence Address: David P. Lhota, Stearns Weaver Miller, Suite 1900, 200 East Broward Boulevard, Fort Lauderdale, FL, 33301, US

(21) Appl. No.: 09/883,132

(22) Filed: Jun. 15, 2001

Related U.S. Application Data
(60) Provisional application No. 60/211,503, filed on Jun. 14, 2000.

(51) Int. Cl. G09B 9/02

(52) U.S. Cl. 434/29

(57) ABSTRACT

A flight instruction educational system and method for learning proper operation of selected aircraft or other types of machinery comprising a plurality of rigid panels forming an upper control deck cantilever assembly, a lower control deck assembly, a plurality of pictorial displays depicting instrumentation affixed to the rigid panels, video player and monitor disposed within the boundaries of the panels, and audio/video storage medium such as a video cassette or DVD containing the instructions and selected scenes for viewing during instructions. The system may also include a central processing unit for administering and tracking instructions and a plurality of switches, levers and gauges that may be actuated to further simulate the feel of operating the aircraft or machinery, wherein the switches, levers and gauges may be electrically coupled to the CPU for monitoring.

### CROSS REFERENCE TO RELATED APPLICATIONS

This application claims the benefit of provisional application Serial No. 60/211,503 filed Jun. 14, 2000.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

This invention relates generally to an educational system for teaching the proper operation of predetermined machinery, and more particularly, to a flight instruction procedures training device that pictorially and/or mechanically provides the look and feel of a cockpit with simultaneous video instruction for familiarizing students with the instrument panel while teaching pre-flight inspections, checklists and various normal and abnormal procedures. The instant invention may also be adapted for teaching the operation of other types of machinery by providing a pictorial display that simulates the operation deck and instrumentation for that machinery and video that instructs student's regarding the operation protocols for the machinery.

2. Description of the Background Art

Learning how to properly operate an aircraft or any large machinery, such as trains and cranes, can be very expensive, time consuming and tedious. With respect to learning how to fly, flight instruction begins with ground school training. In ground school training students memorize checklists for various pre-flight, takeoff, flight and landing experience protocols, and spend little to no time in a cockpit. Some form of ground school training and memorization of protocols is also required for learning how to operate other types of machinery. This is often done without the benefit of an actual or simulated cockpit or cabin. Merely memorizing proper protocol checklists provides limited educational value to the flight student.

In learning how to operate any piece of equipment, a considerable amount of time is spent developing large motor movement habit patterns, such as where to look and reach, what one should expect to see or hear, and where to move and position the hands to complete one step and be ready for the next step. Sitting in the machine or a full motion simulator to practice proper operations with a qualified instructor has proven to be the best situation for learning how to operate a piece of machinery. However, the costs are expensive for such high end training and such training simulators are not often available or working. Students' ground school education could be enhanced and more productive if they could experience the general look and feel of a cockpit during initial training without having to sit in an aircraft, machine or simulator. For instance, one of the major elements of learning to fly a particular aircraft is learning where to look and reach during a procedure, as well as the distance to reach and proper sitting positions. It is also important that commands, call-outs and responses be verbally practiced. While flight simulators and actual aircraft can provide this type of ground school training, they are expensive and not conveniently available and require an additional person, training partner or instructor to provide the experience. In addition, traditional simulators are not collapsible or transportable for use in a student homes or any other desired location. There are no known simple devices that facilitate ground school training in a cockpit-like setting. In fact, there are no known devices that can inexpensively train personnel to operate machinery with a simple mechanical or semi-dynamic simulator.

Aircraft simulators and computer-aided flight training programs are known in the art. However, none of these addresses or solves the problems noted above. Rather, the aircraft simulator systems known are too complex and expensive for repetitious ground school training. Computer screens, while providing dynamic instrument involvement do not adequately represent the flight deck or other operating station. The prior art fails to provide a simple architecture for enhancing ground school training as contemplated by the instant invention. For instance, U.S. Pat. No. 5,727,188, issued to Hayes, discloses a flight control simulator for computer games. The device does not provide the operator with the ability to practice proper placement of hands on switches and controls and their location. U.S. Pat. No. 5,409,307 discloses a combined computer and vehicle simulator cockpit desk comprising a fixed desktop portion, removable desktop portion, simulator seat that faces the desk and computer screen, joystick and rudder pedals. The interaction is only with a computer screen and not with a cockpit layout in the furniture. U.S. Pat. No. 5,388,990 discloses a virtual reality flight control system that displays the image of a scene surrounding a vehicle or pod having six degrees of freedom of acceleration and velocity. The student interacts with computer screens in an expensive system. U.S. Pat. No. 4,852,031 discloses a cockpit simulator device, including switches, instruments and control yoke, that interfaces directly with the keyboard port of a desktop computer. This device uses additional switches to control a computer, but does not place the switches in locations where they would be found in an actual aircraft. U.S. Pat. No. 4,787,024 discloses a flight simulator interface system comprising a host computer, master-interface circuits and slave circuits that drive instrument displays. The foregoing disclosures fail to disclose a mechanically simulated, three-dimensional, collapsible and deployable cockpit for aircraft or other machinery that visually and spacially simulates the look and feel of a cockpit or operation deck in combination with an instruction video in a manner that fills in the void between the old methods and devices known for ground school training and expensive flight simulators.

As the above-noted devices and systems only disclose complex and expensive aircraft simulators, there exists a need for a simple, inexpensive system that facilitates more effective ground school training in a pictorially simulated cockpit environment. The instant invention fulfills this need by providing a mechanical, three-dimensional, collapsible, transportable and deployable aircraft or machinery simulator that recreates the life-size look and feel of a cockpit and provides video having instructions prerecorded thereon.

### BRIEF SUMMARY OF THE INVENTION

Based on the foregoing, it is a primary object of the instant invention to provide instruction and ground school training for teaching the operation of aircraft or other machinery to those who would not otherwise have access to simulator type training.

It is another object of the invention to provide a three dimensional, mechanical simulator comprising the combination of a primarily mechanical architecture that pictorially simulates the look and feel of a flight deck instrumentation panel and a device that plays and displays audio and video instructions relative to the instrumentation for providing ground school training.

It is an object of the invention to provide a simple and cost effective ground school flight procedures mechanical training simulator that simulates the general look and feel of an aircraft cockpit, familiarizes students with flight deck instrumentation and provides instruction on proper protocols and/or procedures for handling various experiences related to pre-flight, take-off, flying and landing and other normal and abnormal situations in a particular aircraft.

It is another object of the invention to provide a simple and cost effective ground school flight procedures training device that simulates the general look and feel of an aircraft cockpit by providing a pictorial display of the flight deck instrumentation, video instructions on proper protocols for various experiences related to pre-flight, take-off, flying and landing and a video display positioned within the pictorial display to simulate the cockpit window and various images and scenes viewable from the cockpit and/or used for providing instructions. For example, a “push back” operation may be shown as seen from the cockpit.

It is also an object of the instant invention to provide a ground school flight procedures training mechanical simulator that pictorially simulates the general look and feel of an aircraft cockpit and may provide switches and gauges mounted to the pictorial representation and video for instructing proper protocols for pre-flight, take-off, flying and landing experiences.

It is an additional object of the instant invention to provide an educational device that pictorially simulates the operation deck of a predetermined piece of machinery and provides audio and video instructions that teach the proper operation of the machinery, including the location of instrumentation as depicted by the pictorial display.

It is a further object of the instant invention to provide a ground school flight procedures training mechanical simulator that is collapsible, transportable and deployable.

In light of these and other objects, the instant invention provides a static flight deck procedures mechanical training device, system and method (referenced herein as a “training simulator”) that is collapsible, transportable and deployable and comprising a rigid, adjustable and contoured pictorial display of an aircraft flight deck instrumentation panel with related controls and gauges depicted thereon (“simulated instrument panel”), video display device strategically positioned in the procedures training device and audio/video equipment for providing instructions, interactive lessons and tests on proper procedures and protocols for handling various pre-flight, flight and landing experiences. The simulated instrument panel provides the look and relative positioning of the instrumentation, such as switches and gauges. The training simulator may also be dynamic or semi-interactive whereby the student responds to video/audio commands by locating, engaging and/or actuating proper controls and gauges in response to questions or hypothetical situations. A software program may also be provided to provide and record testing and to determine whether the proper controls were properly located and engaged. The training simulator mechanically simulates the dimensions and positioning of the instrument panels and the location of switches and gauges in a three dimensional station that teaches students where to look and reach in various situations and the proper call-outs to make. The method and system of the invention teaches students proper procedures prior to spending expensive time in an actual cockpit, simulator or other piece of machinery. The training simulator differs from traditional ground school training in that it provides a collapsible, transportable and active, audio and visual display of instructions that might be used at home or at a school location. Accordingly, the instant invention integrates a static pictorial display or minimally dynamic training simulator that replicates flight deck instrumentation with a device that delivers and displays video, audio and pictorial instructions.

The preferred embodiment of the instant invention comprises a flight instruction educational training simulator and method for teaching flight deck instrumentation and proper protocols for handling various aircraft experiences. The preferred embodiment of the training simulator generally comprises a three-dimensional simulated instrument panel including a plurality of rigid panels and a cantilevered overhead assembly having pictorial displays of the flight deck instrumentation, a video playing device, a video display preferably positioned within the rigid panels at a location corresponding to the front window, an audio system and an audio-video medium having the educational instructions and courses stored thereon. The training simulator may also include a frame and cantilever supports for supporting the panels in the proper orientation. The pictorial display is mounted to, adhered to or otherwise made to be a component of the panels, which are placed in positions and locations corresponding to a known or simulated cockpit. The video monitor is preferably positioned to simulate the window through which a pilot or operator would normally look. This placement facilitates the display of scenes and situations to simulate different flight or control experiences, as well as displaying instructions and lessons to the student. The video display or monitor may comprise a television, computer video monitor, projection screen or other known video display device. The video playing device may comprise a VCR, computer with a video player, CD-ROM player such as those commonly found with computers or a DVD player. The video visually and audibly instructs and tests the student on which switches, gauges and levers to find, look at and/or actuate, as well as the proper calls to make in various simulated situations. In other embodiments, the invention may have switches, levers, and gauges, that are either electrically active or inactive, mounted to corresponding panels for simulating the general tactile feel of flight deck instrumentation. The invention may also employ interactive software, a voice activation system and/or semi-live switches, gauges, levers, lights and the like that interact with software to test a students knowledge of the controls and procedures.

In alternative embodiments, the invention may comprise an instruction educational system for teaching students how to operate other types of machinery wherein the pictorial displays, switches, gauges and audio-video instructions would correspond to the subject machinery. Although the discussion and description of the invention herein primarily describes an aircraft cockpit, the structure and function may be adapted to other types of machinery, such as power plant control consoles, fork lifts, boats, ships, tractor trailers, manufacturing work stations and other machines, without departing from the scope and spirit of the invention.

### BRIEF DESCRIPTION OF THE SEVERAL VIEWS OF THE DRAWINGS

FIG. 1 is a front illustrative and perspective view of the preferred embodiment of the instant invention, as employed, illustrating an upper control panel with a first pictorial, a lower control panel with a second pictorial, a video display and a video playing device.

FIG. 2a is a front elevated view of the preferred embodiment of the instant invention illustrating a video monitor, video player and a plurality of control panels.

FIG. 2b is a side elevational view of the preferred embodiment of the instant invention illustrating a video monitor, video player and a plurality of control panels.

FIG. 2c is a rear elevational view of the preferred embodiment of the instant invention illustrating a video monitor, video player and a plurality of control panels.

FIG. 3 is system block diagram of the computer or processor based system of the instant invention.

FIGS. 4A-4C are logic flow diagrams of the steps and procedures of the preferred embodiments of the instant invention, illustrating a sequence of steps for the television mode and computer mode, respectively.

### DETAILED DESCRIPTION OF THE INVENTION

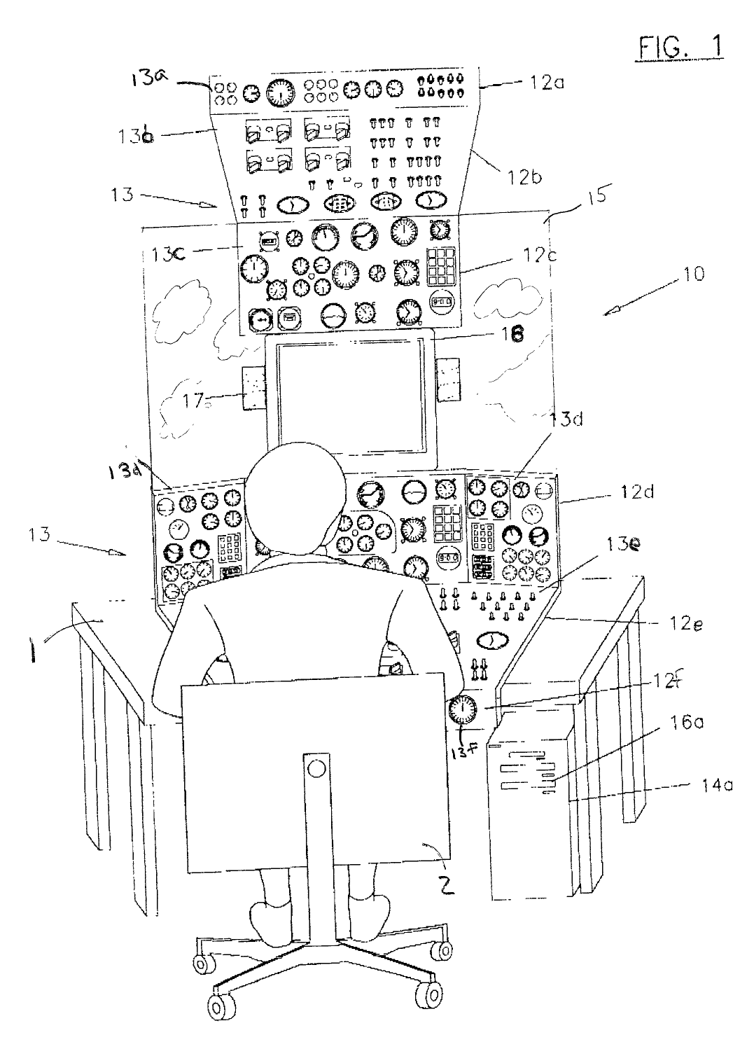

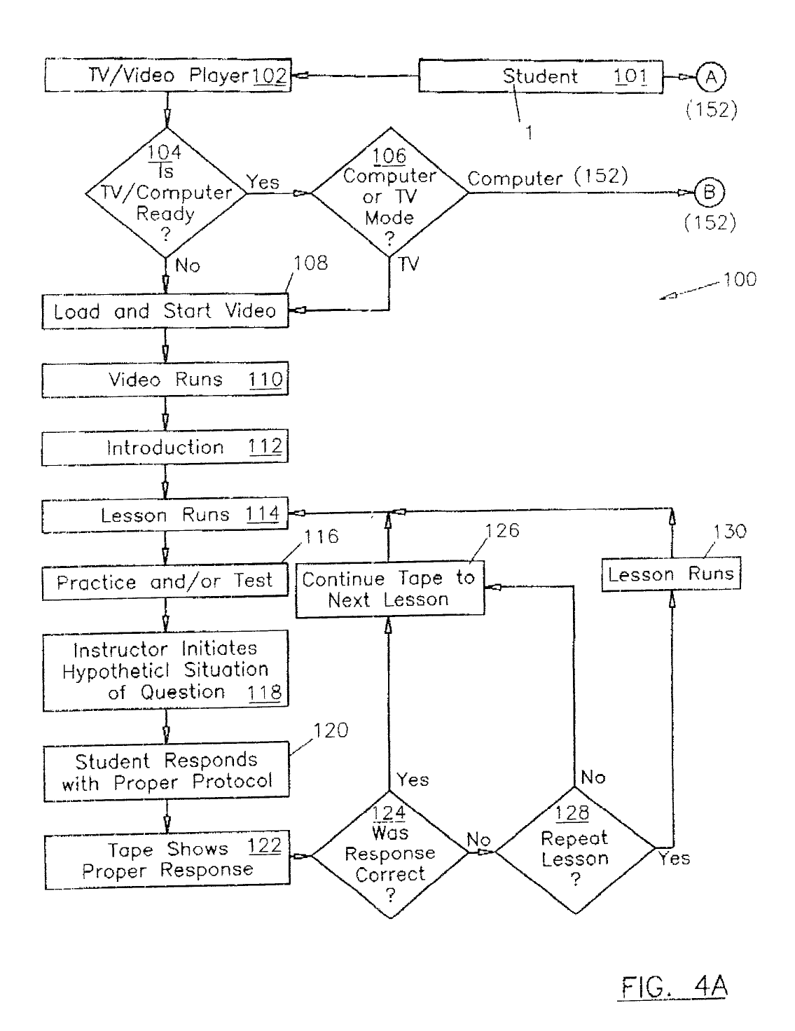

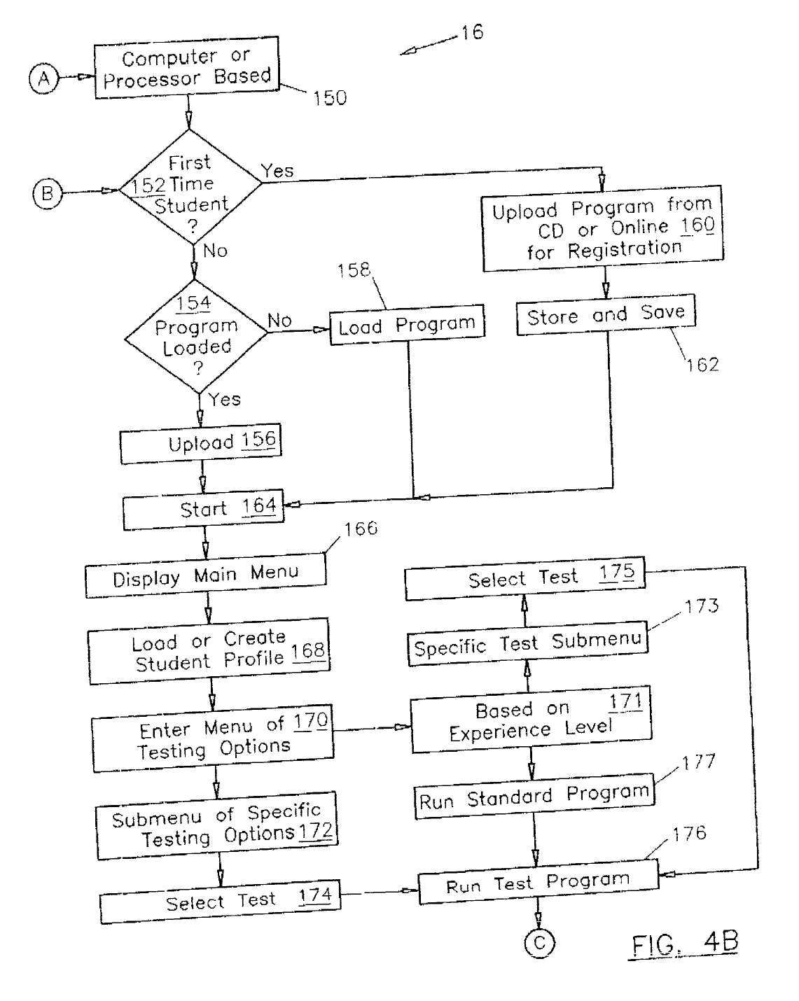

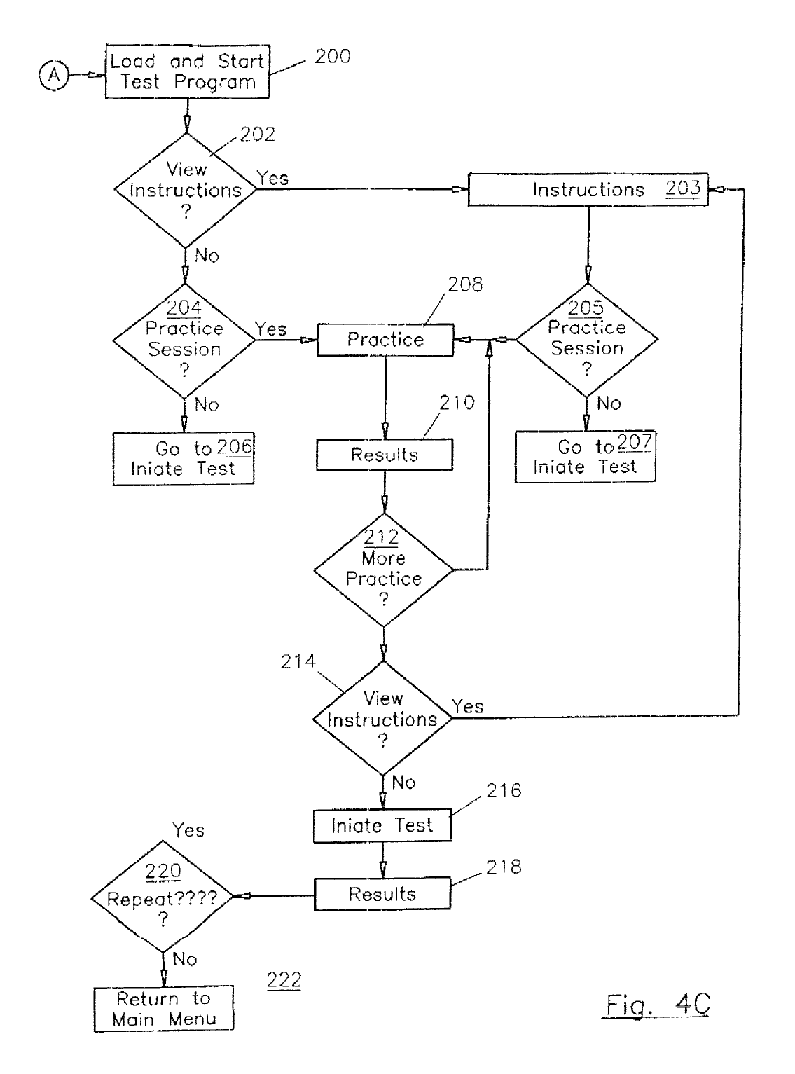

With reference to the drawings, FIGS. 1 to 4c generally depict the preferred embodiments of the instant invention, which comprises a machine operation and procedures training simulator, generally characterized by numeric character 10 and/or as a training simulator 10, for teaching and/or learning the proper operation and protocols of a pre-selected aircraft, in the preferred embodiment, or other types of machinery, such as trains or cranes, in alternative embodiments. The training simulator 10 comprises a three dimensional, collapsible, transportable and deployable mechanical simulator in combination with an audio/video storage medium and/or player for recording, storing and providing instructions and interactive lessons. The training simulator 10 comprises a system of selected combinations of the below noted components and method for teaching the operation of an aircraft or other selected machinery in a simulator program 100, shown in FIGS. 4a-4c.

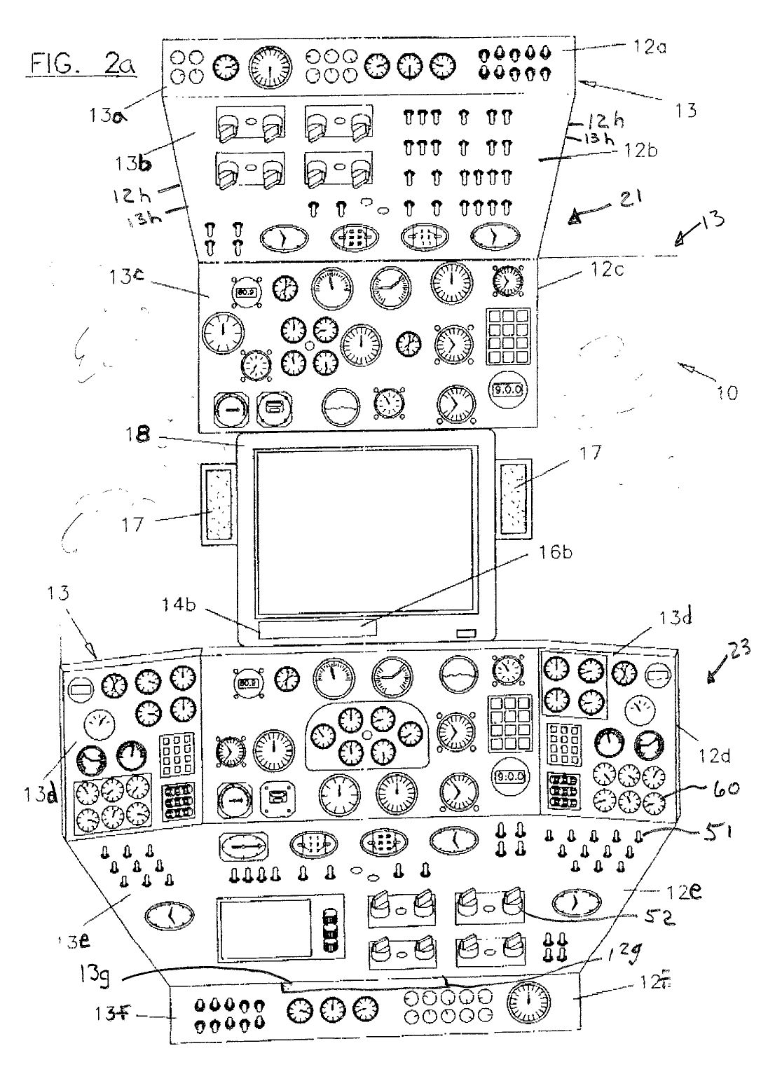

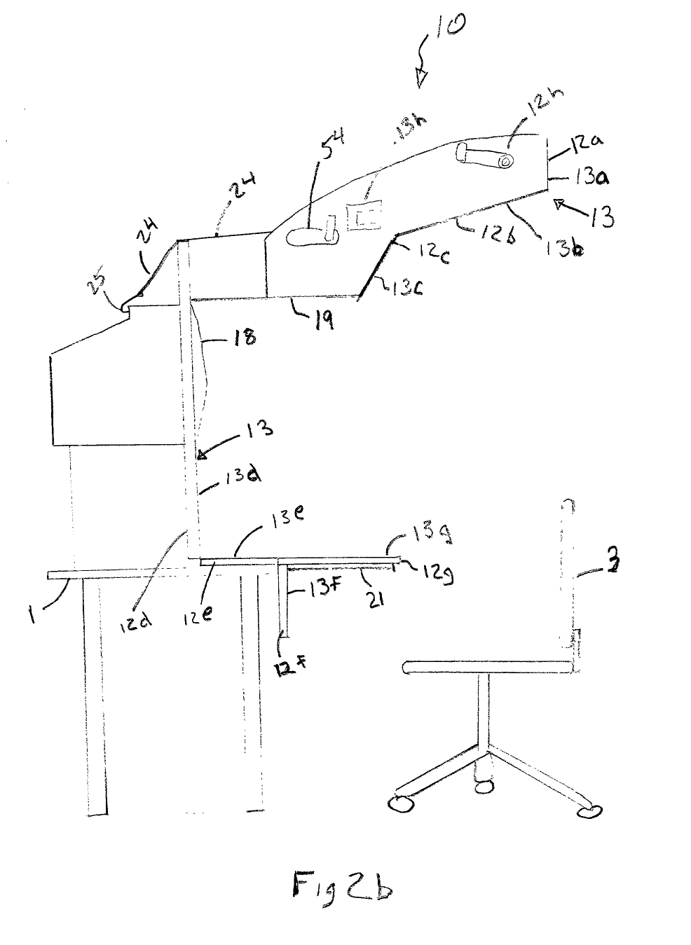

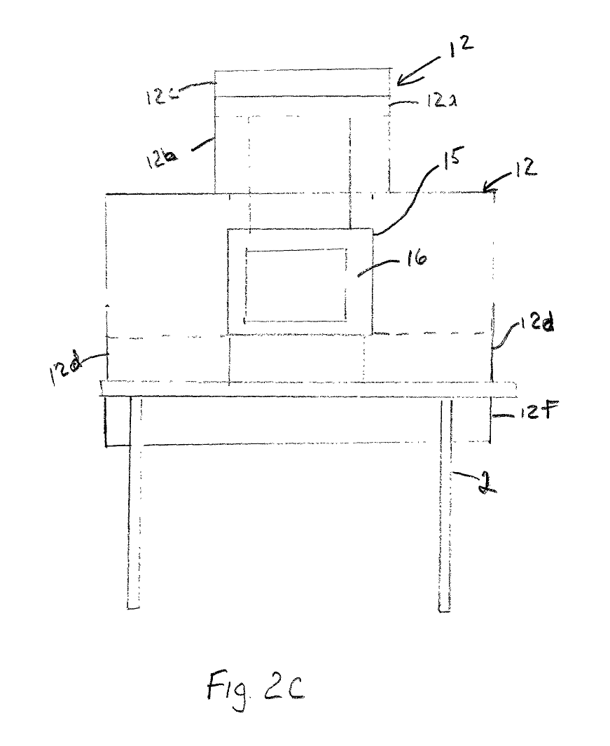

With reference to FIGS. 1-2c, the preferred embodiment of the invention 10 generally comprises at least one and preferably a plurality of rigid panels 12a-h (collectively 12), a plurality of corresponding pictorial displays 13a-h (collectively 13) of the flight deck instrumentation for at least one predetermined aircraft attachable and/or affixed to the panels 12a-h, respectively, audio/video storage device, such as a video cassette or DVD 16b, compact disk 16a or digital media file, and video monitor 18 preferably positioned within the boundaries of or between the rigid panels 12 at a location 15 corresponding to a predetermined view from the aircraft or machinery such as the front window. In alternative embodiments, the training simulator 10 may also include an audio/video system that includes prerecorded instructions and lessons stored on a storage medium, such as a video cassette or DVD 16b, compact disk 16a or digital media file, an audio/video playing device, such as video or DVD player 14a or central processing unit (CPU) 14a, adapted for playing a corresponding storage medium 16a or 16b having the proffered educational courses, instructions and/or tests stored thereon (simulator program 100, as shown in FIGS. 14A-C), video monitor 18 and speakers 17. The video monitor 18 may comprise a television screen or computer monitor positioned in relation to panels 12 in one location or at various locations for creating and simulating predetermined views in accordance with instructions, lessons and/or tests being run from the storage medium. In embodiments employing a CPU 14a, software may be included to manipulate and run digital media files, log and track results and provide more overall interaction between the student and the training simulator 10. The training simulator 10 may also include structure for supporting and suspending certain panels, such as tension lines 24, hooks 25, brackets, braces and the like, in positions that simulate the geometrical dimensions and positions of instrumentation found on the operation or flight deck of predetermined aircraft or machinery.

With reference to FIGS. 1, 2a-2c, the training simulator 10 comprises at least one and preferably a plurality of rigid panels 12 having attached or attachable thereto pictorial displays 13 of the simulated switches, levers, gauges and controls. The panels 12 may comprise materials such as Bristol board, card board, plastic, particle board or wood. The panels 12 are preferably grouped and hinged together in predetermined sets, such as an upper set of controls in an upper-cantilevered assembly 21 and a lower set of controls in a lower deck assembly 23. The hinged connection between the various panels 12a-12h facilitate convenient collapsing, folding, transporting and/or storing of the training simulator 10, as well as convenient deployment and set-up of the simulator 10. The lower deck assembly 23 preferably rests on a desktop, table or comparable structure. The lower deck assembly 23 comprises pictorial displays 13d, e, f and/or g supported on panels 12d, e, f, and/or g. Panels 12d-12g define a multi-tiered, three dimensional structure comprising a substantially vertically oriented panel 12d hinged at its lower end to a corresponding inside edge of a substantially horizontally oriented panel 12e and panel 12f hinged at its upper edge to the outside edge of panel 12e. Panel 12g and pictorial 13g may also be used. Panel 12g comprises a substantially horizontally cantilevered suspended panel that projects outward toward the student and is supported at one end in a slot defined by panel 12f, as shown in FIGS. 2a and 2b. The upper cantilever assembly 21 comprises panels 12a-c and h suspended outward over the student's head with braces, such as tension lines 24 attached at one end to at least on panel 12a-c, h and at the opposite end to a fixed structure, such as to the back of the monitor 18 with a hook 25. The plurality of rigid panels 12 may be hinged together by tape, stitching or hardware in a manner that allows the panels to be adjusted to correspond to the look, feel and contoured layout of a cockpit or other desired machinery. The panels may also comprise a single set. The invention may also include a frame or frames (not shown) for providing support to the panels 12.

The pictorial displays 13 are mountable or mounted to the panels in positions and locations corresponding to a known or simulated cockpit. The displays 13 may be adapted for various types of aircraft and/or come in sets. The displays 13 may be pre-attached to the panels 12 with adhesives, tape, stitching or hardware or releasably attachable thereto with reusable adhesives or cooperating magnetic surfaces on the back side of the pictorials and the front side of the panels. The panels 12 and pictorial displays 13 may be made from cooperating magnetic sheets for removing and replacing, so the instructor or student can use the same panels 12 for simulating different aircraft with different pictorial displays 13. The pictorial display 13 of the instrumentation is adhered and/or mounted to the front face of the panels to convey to the student the visual image of a cockpit and corresponding instrumentation.

The video monitor 18 is preferably positioned to provide visual and audible instructions or to simulate the window through which a pilot or operator would normally look. This placement facilitates the display of scenes and situations to simulate different flight or control experiences, as well as displaying instructions to the student. The video display or monitor 16 may comprise a television, computer video monitor, projection screen or other known video display device. The video playing device 14a or 14b may comprise a VCR, computer with a video player, CD-ROM player such as those commonly found with computers or a DVD. Speakers 17 should also be provided to facilitate audible instructions. The video visually and audibly instructs and tests the student on which switches, gauges and levers to find, look at and/or actuate, as well as the proper calls to make in various simulated situations.

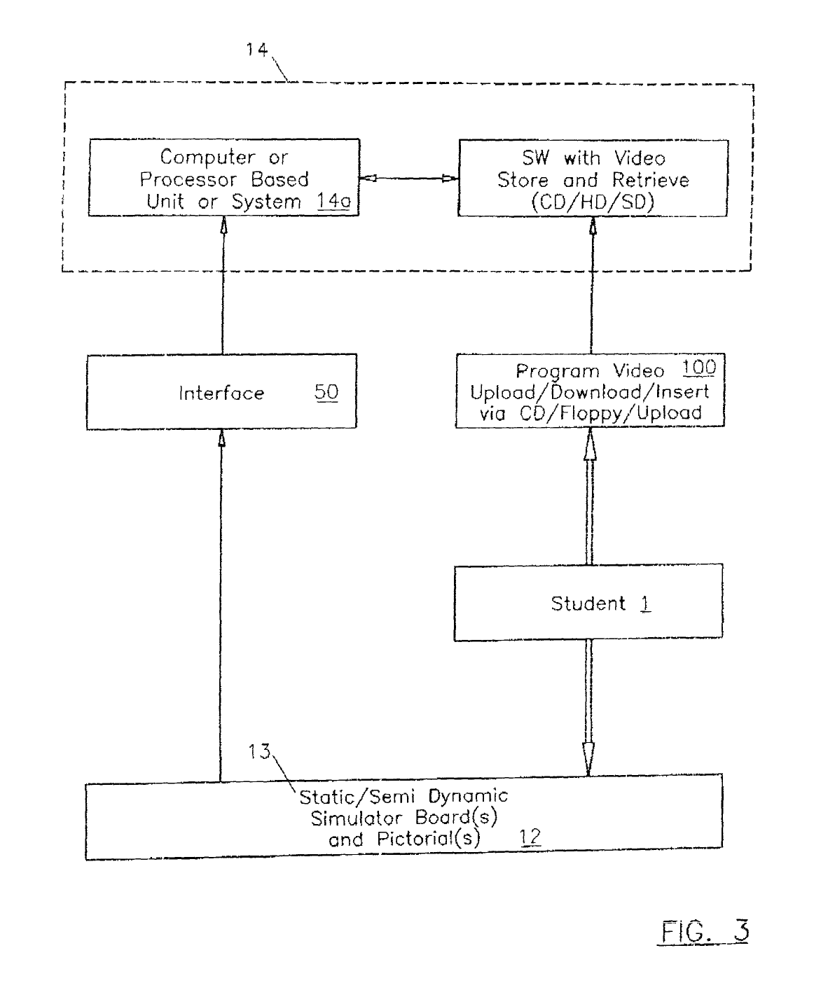

With reference to FIG. 3, in one embodiment the training simulator 10 may employ a video player 14 that comprises a computer 14a or other processor-based unit capable of reading and processing a set of instructions, a corresponding storage medium 16, such as a compact disc, hard drive, DVD or digital media file and at least one audio-video simulator program 100 comprising at least one course, instructions, lessons, practice sessions, and/or tests stored thereon and/or a plurality of processor readable instructions (software code) for running the program 100. In other embodiments, the panels 12 may include actual tactile switches 51, knobs 52, levers 54 and gauges 60 for further simulating the look and feel of an aircraft or other machinery. The switches 51, knobs 52, levers 54 and gauges 60 (collectively referenced as switches and gauges 51-60) may be inactive or active. By providing switches and gauges 51-60, whether inactive or active, the student can learn the actual look and feel as well as the location of the instrumentation. If the switches and gauges 51-60 are to be active then they must be used with a CPU 14a having software processing code and placed in electrical communication with the CPU 14a. In this embodiment, the program 100 and software code identifies which switches and gauges are actuated and used and produces corresponding audible and/or visual results to determine if proper procedure was followed. The switches and gauges 51-60 could be electrically connected to electronic circuits, such as a small voltage sources and various resisters, transistors, integrated circuits and/or relays in a manner that produces readable values at the computer 14a, which are convertible to values that are readable and displayable by the program 100. The program 100 can identify and read the switches, levers and gauges 51-60 based on electrical levels, such as voltage levels, current levels, resistance values, or the position and status of relays corresponding to the instrumentation, or by other devices and methods known in the art.

In another embodiment, as shown in FIG. 3, the training simulator 10 may include an electrical interface 50 that includes such circuitry for conditioning the signals into values and forms that may be processed by the software program 100. The switches and gauges may be electrically linked to a computer board via a serial bus, RS-232 connector or other known devices in the art. The invention may also be voice activated to test whether the student is making proper calls. Alternatively, the switches and gauges could correspond to different keys on a standard keyboard such that a simple software program provided by the invention could ascertain whether the student is properly responding to tested situations. The program 100 could be designed to prevent advancement until prior skills were mastered and/or to instruct the student on correcting mistakes.

FIGS. 4a to 4c illustrate the use of the invention 10, method of using the training simulator, method of teaching the operation of aircraft or other predetermined piece of machinery and the software program 100 in accordance with the preferred embodiments of the instant invention. The student 1 begins by selecting a program or lesson and loading the appropriate video cassette, DVD, compact disk, digital media file or CPU operated program. The program 100 and video 14a or 14b may begin with a description of the instruction to be covered, such as a preflight, air and/or landing training and operating procedures standardization program and/or checklist. With reference to FIG. 4A, a student 1 first decides which version of invention will be used, the television version of the training simulator 10 (as depicted in steps 102 to 130) or the computer/processor based version of the training simulator 10 (as depicted in steps 150-222). The invention 10 may include printed, audio/video or software driven instructions 100 on setup, startup and operation of the training simulator 10 according to the embodiment being employed. The video and audio based educational recording, as depicted in FIGS. 4A-C and stored on and played from the playing device, can typically begin with a description of the aircraft or machinery being covered in the current and/or subsequent instructions, lessons, training and/or testing. With reference to FIG. 4A, if the student selects tv/video option 102, a check may be implemented to see if the television employed is computer ready, i.e. processor based or connected. If yes, then the computer version should be used. If not, which is typical, the student loads and starts the video 108. If no, then the television version is employed and a DVD player or VCR player and DVD or video, respectively, would be provided and used. After loading and starting the video 14, it begins with an introduction 112, such as a description of the aircraft or machinery, including specifications and particulars, and where the preflight or other instruction will begin. The lesson and/or checklist may be covered next, followed by a practice session or test session. Introductions, checklists, lessons, practice sessions and/or test sessions may be repeated prior to continuing forward in the video instruction 14, although not fully shown in the drawings. In a practice or test session, an instructor can introduce or initiate a hypothetical situation related to the current lesson being taught 118. The student 1 responds with a call, reach, reaction, protocol steps, key stroke or other action depending on the version of the invention employed. In the video 14 follows or continues with the proper response and the student 1 can decide whether their response was correct, whether to repeat the lesson or test or to continue to the next lesson 120-130.

A typical introduction, lesson or practice session is shown for starting the right engine of a HU-16 Grumman Albatross, as follows:

I. Introduction. The goal of this procedures trainer is to familiarize you with:

A. The location and placement of the controls of the HU-16 Grumman Albatross.

B. What to do with the controls.

C. The timing required for performing certain operations.

II. A sample procedure for starting the right engine of the HU-16 Grumman Albatross

A. Introductory Statement: Starting an Albatross is becoming a lost skill as fewer and fewer pilots operate “round engines.” If not done correctly, the starting of a radial engine can severely shorten the life of the engine. If done by an experienced “round engine” pilot, it seems effortless.

B. Assumptions: For this exercise we will assume the checklists are completed up to the point of actual engine start. The normal starting process involves the follow 10 steps, takes a little over a minute, and is just one of the thousand or so normal operations required to operate this airplane.

III. Steps for Starting the HU-16 Grumman Albatross

A. Instruction: Pre-oil the engine. The purpose of pre-oiling the engine is to increase the life of the bearing surfaces. It is accomplished with an oil pump that is electrically operated prior to engaging the starter and turning the engine over. The pilot accomplishes pre-oiling by pushing forward the right engine pre-oil switch and waiting until the right engine oil pressure increases and stabilizes.

B. Action: Place your right thumb on the right pre-oil switch, push forward and hold the spring-loaded switch to the “on” position. Look at the right engine oil pressure gauge and wait for the needle to rose to about 20 psi and stabilize. When you push the switch, you will hear a slightly high-pitched whine. The engine gauge cluster in the video is different than the one on the poster, but the gauge works the same way.

C. Instruction: The starter is engaged by pushing on the large black starter button, similar to the way the starter was engaged on older automobiles. It requires about as much pressure as pulling the trigger on a cordless drill. The starter button must be continually pushed down until the engine is either started of the start attempt is abandoned. If it is disengaged and immediately engaged there is a chance of damaging the starter drive.

D. Instruction: When operated from the left seat, the starter button is pushed down by the index finger of the left hand. This seems initially strange since the button is on the right side of the operator. The reason the left hand is used instead of the right is because the right hand is required to operate other controls on the overhead panel. It is almost physically impossible to hold the starter button with the right index finger and operate the overhead controls with the left hand. This is true no matter whether the left or right engine is being started.

E. Instruction: When the starter button is engaged, the other pilot will count the propeller blades as the engine is turning over. Expect to hear a count of one to twelve. The reason we count twelve blades before starting is that the engine is allowed to turn over two complete cycles before firing. This provides an opportunity for the clearing, or at least discovering a “hydraulic lock.” A hydraulic lock usually occurs when one of the bottom cylinders of a radial engine fills with oil due to a leaky check valve. If it is not cleared, either by turning the engine over or, in severe cases, by removing the bottom spark plugs and allowing the oil to drain, before the engine is started, the result will probably be a bent connecting rod, broken piston or damaged cylinder. It the engine starts to turn over and stops, discontinue starting and Investigate the cause.

F. Action: Turn slightly in your seat toward the center of the Instrument panel and put your left index finger on the right engine “Starter button.” Push down and hold. You can expect to hold It for about a minute. Listen while the other pilot counts from one to twelve. When the count reaches ten, start reaching for the right booster pump on the right side of the overhead panel.

G. Instruction: Without the booster pump being on, there would be no pressure to the primer valve. So the booster pump must be turned on before the primer button is pushed.

H. Action: With your right Index finger switch the right booster pump “on.”

I. Instruction: After switching on the booster pump, move your right hand to the center of the overhead panel to the magneto control. The ignition master will have already been pushed in during the “Before start checklist.” Put your right thumb around the Ignition master and with your right index finger, snap the right magneto butterfly switch forward as far as it will go. It has four positions. From the three o'clock position to the forward position they are: “off, right mag, left mag, and both.” The engine is started with the switch in the “both” position. In the “both” position, both of the right engine magnetos are operational and fire the spark plugs.

J. Action: Switch the right engine magnetos on and move your right hand to the right mixture control.

K. Instruction: Do not move the mixture control. Just place your right hand on it, because that is the next thing your right hand will operate.

L. Instruction: The engine is now turning (sucking in air) and the spark plugs are firing. In order to run, it needs fuel. In step 3, the booster pump was turned on providing fuel pressure to the primer valve. The primer button is located immediately forward of the starter button. While still holding the starter button down with your left index finger the primer button is depressed and released a few times with the left middle finger. Each time the primer button is pushed, a stream of gasoline is sprayed into the intake manifold, Holding the p6mer button down will flood the engine, so push it, release it, push it release it and so on until the engine coughs and starts to run.

M. Action: Operate the primer.

N. Instruction: When the engine is coughing and sputtering and you are sure that it wants to run, the fuel supply function is transferred from the primer to the carburetor by moving the mixture control from “Idle cut-off” to “normal.” This is the point where many engines are damaged by “backfiring” or “kickback.” The engine must be running on prime before the mixture is moved to “normal.” If the mixture of fuel and air in the cylinder of a slowly turning engine is too lean it will ignite too soon and try to drive the piston down the cylinder before it reaches top dead center. This event tries to make that one piston and connecting rod run backwards against the rest of the engine. It can also start a fire in the induction manifold and carburetor.

O. Action: When the engine sounds like it is running (coughing and sputtering) move the right mixture from “Idle cut-off” to “normal.”

P. Action: When the engine is running on its own, release the starter button.

Q. Instruction: Now that the engine is running, it is important to make sure that it has oil and fuel pressure. If there is something wrong with either indication the engine must be shut down.

R. Action: Look at the engine gages and verify that the oil and fuel pressure gauges are “in the green.”

S. Instruction: The engine driven fuel pump is now providing all the fuel pressure needed, so you can:

T. Action: Turn off the booster pump. Although not shown in the video it is a good idea to check the fuel pressure gauge. There will also be audio clues if there is no fuel pressure: The engine will start to die.

U. Action: Check the RPM and Manifold pressure gauges. Note that at idle they work opposite of each other. Adjust the RPM with the throttle.

IV. Closing Statements

A. The starting process seems to be a complex operation to someone who has never done it before. If a person had to think about what to do next, it would be daunting. That is why it is important to develop enough familiarity with the operation that much of it is done out of habit and not thought out. This allows the operator to concentrate on what the machine is doing and not what he has to do next.

The foregoing provides an example of the content of instructions and actions to take on an audio/video storage medium 14b, 16b. A similar sequence of instructions and actions are available for all aspects of the operating aircraft or piece of machinery.

With reference to FIGS. 4A and 4B, a student 1 may have and/or elect the computer version of the simulator 10. First the program 100, which for purposes of this discussion includes the video and audio instructions 14, is loaded and started 150. An inquiry may be made as to whether the student is a first time or registered student 152. If yes, the registration prompt is made available and if elected a registration process begins 160-162. Once registration is completed or if registration had occurred at a prior time, the program is uploaded and/or started 154-164. A main menu is displayed and made available which may begin with creating or uploading a student profile 168. Thereafter, the menu of instructions, lessons, practice and/or testing options is entered, where a student 1 can elect to enter a selection of the foregoing based on experience level or a submenu of specific testing options 170-172. The option is selected and run after making a selection 173-177. Upon selecting a test, the test program or subroutine is loaded and started 200. An option for viewing instructions may be provided 202 or automatically started 202-203. If elected or automatic, instructions on the aircraft or machinery are provided 203. The student may also elect to enter and execute a practice session to practice particular protocols and review results 204-210. Practice may be repeated 212. At any particular time, instructions may be elected and run to review lessons 214. Test may be initiated and repeated as well 216-220. The main menu may always be returned to 222. There may be interaction with a program, instructor or proctor via telecommunications, remote video conferencing or Internet.

The instant invention has been shown and described herein in what is considered to be the most practical and preferred embodiment. It is recognized, however, that departures may be made therefrom within the scope of the invention and that obvious structural and/or functional modifications will occur to a person skilled in the art.

What is claimed is:

1. A three dimensional mechanical simulator for use in learning how to operate a predetermined piece of machinery having an operator's deck and instrument panel with switches and gauges, said simulator comprising:
a plurality of rigid panels selectively hinged together in a manner that duplicates the dimensions and look of the operator's deck and having pictorial displays resembling the instrument panel with images of switches and gauges;
audio/video storage medium comprising at least one predetermined lesson associated with at least one aspect of the operation of the predetermined piece of machinery, said predetermined lesson comprising instructions for identifying select images from said pictorial displays for a cognizant user to locate and touch.

2. A simulator as recited in claim 1, further comprising:
means for securing said pictorial displays to said rigid panels.

3. A simulator as recited in claim 1, further comprising:
a video display device for showing the content of said audio/video storage medium secured within the boundaries of said rigid panels at a predetermined location that facilitates the viewing of said audio/video storage medium by a cognizant user.

4. A simulator as recited in claim 1, wherein said rigid panels further comprise:
an upper cantilever assembly formed by at least one of said rigid panels projecting outward to simulate controls appearing over a cognizant user's head.

5. A simulator as recited in claim 4, further comprising:
means for supporting and suspending said upper cantilever assembly outward in front of said rigid panels.

6. A simulator as recited in claim 5, wherein said means for supporting and suspending comprises a tether affixed at one end to said upper cantilever assembly and at an opposite end to a fixed, predetermined point defined by said simulator.

7. A simulator as recited in claim 1, wherein said rigid panels further comprise:
a lower deck assembly formed by selected rigid panels from said rigid panels.

8. A simulator as recited in claim 7, wherein said lower deck assembly comprises:
at least one rigid panel (first panel) from said rigid panels disposed in a substantially vertical orientation and having a lower edge;
at least one rigid panel (second panel) from said rigid panels disposed in a substantially horizontal orientation and having an inside edge in mechanical communication with said lower edge and an outside edge; and
at least one rigid panel from said rigid panels suspendable downward in a substantially vertical orientation, said suspended rigid panel having an upper edge in mechanical communication with said outside edge of said second panel.

9. A simulator as recited in claim 8, wherein said lower deck assembly further comprises:
a rigid panel (fourth panel) suspendable outward from said second panel and having an inside edge in mechanical communication with said second panel; said fourth panel being securable to said second panel from said inside edge and being extendable outward from said second rigid panel.

10. A simulator as recited in claim 9, wherein said lower deck assembly further comprises means, defined by said second rigid panel, for securing said fourth panel.

11. A simulator as recited in claim 9, wherein said means for securing said fourth rigid panel a slot defined by said second panel for receiving said inside edge of said fourth rigid panel so as to provide cantilever support.

12. A simulator as recited in claim 11, wherein said means for securing said fourth rigid panel comprises a platform insertable in said slot.

13. A simulator as recited in claim 1, further comprising a plurality of switches, gauges and levers for actuating when instructed to do so.

14. A simulator as recited in claim 13, further comprising means for indicating when a switch, gauge or lever has been actuated and whether the right switch, gauge or lever was actuated.

15. A simulator as recited in claim 14, wherein said means for indicating comprises a visual or audible signal.

16. A simulator as recited in claim 14, further comprising a central processing unit in communication with said switches, gauges and levers, said central processing unit comprising said means for indicating.

17. A simulator as recited in claim 16, further comprising a set of processor readable instruction in communication with said central processing unit for accessing and running said at least one predetermined lesson.

18. A simulator as recited in claim 1, further comprising means for playing said audio/video storage medium.

19. A simulator as recited in claim 1, wherein said audio/video storage medium comprises a video cassette.

20. A simulator as recited in claim 1, wherein said audio/video storage medium comprises DVD.
